(19) United States
(12) Patent Application Publication
(10) Pub. No.: US 2005/0041576 A1
(43) Pub. Date: Feb. 24, 2005

(54) Access control to a data network to ensure quality of service

(76) Inventors: Alban Couturier, Chatillon (FR); Nathalie Charton, Montrouge (FR)

Correspondence Address: SUGHRUE MION, PLLC, 2100 PENNSYLVANIA AVENUE, N.W., SUITE 800, WASHINGTON, DC, 20037, US

(21) Appl. No.: 10/497,028

(22) PCT Filed: Nov. 25, 2002
(86) PCT No.: PCT/FR02/04029

(30) Foreign Application Priority Data
Nov. 29, 2001 (FR) 01/15428

(51) Int. Cl. H04L 12/28; H04L 12/56

(52) U.S. Cl. 370/229; 370/395.21

(57) ABSTRACT

The invention concerns an access controller (AC) to a data network (N) including a set of boundary equipment (R₁), characterized in that it comprises: receiver means for receiving quality of service requests associated with packet flows; verification means for verifying whether said request can be fulfilled by internal resources of the network; transmission means for transmitting to the boundary equipment corresponding to the request, a message authorizing or inhibiting transmission of the associated packet flow.

The present invention relates to managing quality of service in a data network. It applies particularly to data networks providing different services, such as transmission of voice, data, video, etc. A network of this kind may be based on the Transport Control Protocol/Internet Protocol (TCP/IP) family, for example, i.e. of the type usually called Internet protocols.

Certain services necessitate explicit reservation of resources within the network.

In fact, some networks, such as the Internet, have been designed to transmit data but neither voice nor video. Within the Internet, transmission takes the form of packets, each packet being routed independently of the others. Now, the transmission of voice and video, for example, necessitates minimizing the packet loss rate and the transmission delay, to ensure sufficiently comfortable listening or viewing for the receiver of the transmission.

The packet loss rate and the delay are conventionally minimized by reserving resources in nodes (or routers) of the network.

Conventionally, a terminal requiring a certain quality of service for a certain flow transmits a quality of service request before sending the packets corresponding to the flow.

Hereinafter, the expression “flow” signifies a “microflow”, i.e. a set of packets conventionally characterized by the following quintuple of information: the protocol used, the address and the port of the sender, and the port and the address of the receiver.

This quality of service request is generally a resource reservation request, for example, conforming to the ReSerVation Protocol (RSVP) as defined by RFC 2205 of the Internet Engineering Task Force (IETF).

According to the RSVP, each router receiving a resource reservation request must first verify that it has the requested resources and route the request in accordance with conventional routing algorithms. The resource reservation requests therefore follows the path that will normally be that of the packets of the flow, as far as the receiver, which then sends a response to the original sender that travels back along the same path. During this second passage, each router must actually reserve the requested resources.

This protocol has a major drawback in that it necessitates, for each quality of service request addressed to a network, reserving resources on a large set of routers and, in practice, maintaining a processing context within each router.

This drawback is eliminated by the Differentiated Services model (DiffServ) architecture as defined by IETF RFC 2475.

According to this architecture, quality of service management is effected by assigning priorities, which are called colors in this context, to each packet of the flow. The routers receiving packets that have been “colored” in this way (i.e. to which a priority has been assigned) must give priority to processing them.

However, these two solutions are complementary, with the result that the prior art solutions generally use both protocols simultaneously, to exploit their respective advantages.

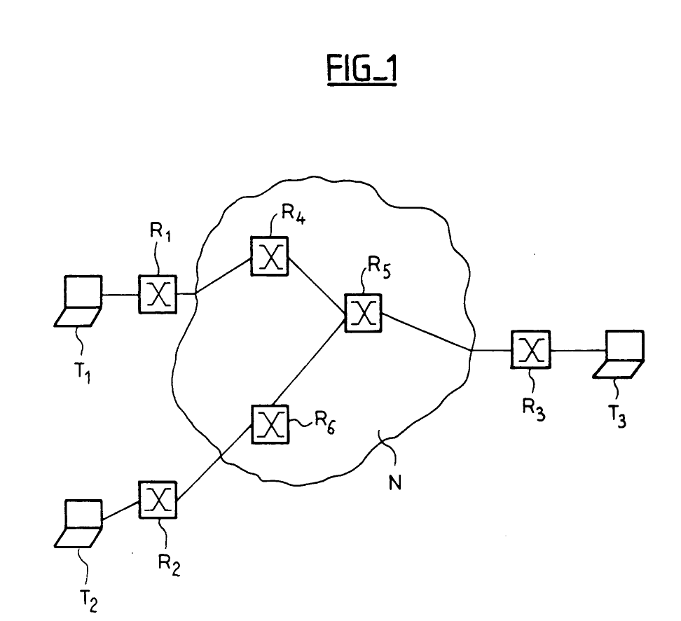

FIG. 1 shows one example of a prior art solution of the above kind. This prior art is described, for example in RFC 2998 “A Framework for Integrated Services Operation over DiffServ Networks” adopted by the IETF in November 2000.

The data network N comprises routers R₁, R₂, R₃, R₄, R₅.

Certain of these routers are edge routers R₁, R₂, R₃, i.e. they have means for communicating with terminals or routers external to the data network N.

The other routers are internal routers R₄, R₅, R₆ which have no means of communication other than with other routers of the data network N.

The network may comprise other types of edge equipment in addition to edge routers, for example gateways whose function is to transmit and format flows without performing any Internet Protocol (IP) routing.

According to this prior art, the edge equipments (routers, gateways, etc.) may use the RSVP, whereas the internal routers mainly use the DiffServ mechanism. The edge equipments have the additional responsibility of translation, or interworking, between the two protocols. It should be noted, however, that certain internal routers may use the RSVP, only a core network using the DiffServ mechanism.

Accordingly, if the terminal T₁ initiates a flow with the terminal T₃ necessitating a certain quality of service (for example a voice call that necessitates, among other things, a minimum bit rate), it sends a resource reservation request using the RSVP.

This resource reservation request is received and then processed by the edge equipment R₁. It verifies that it actually has sufficient internal resources to provide the expected quality of service (i.e. that the current value resulting from the aggregation of the flows at the output of the router R₁ enables the new flow to be accepted).

Where appropriate, the edge equipment R₁ may then transmit a response to the terminal T₁ to tell it that the resources have actually been reserved.

The terminal T₁ then transmits the packets of the flow to the destination terminal T₃.

One receiving them, the router R₁ assigns them a priority as a function of the resource reservation request previously received.

As previously stated, this priority is conventionally assigned in accordance with the DiffServ mechanism.

The priority packets are then routed within the data network N, through the routers R₄, R₅ and R₃. Each of these routers processes the packets that it receives as a function of the priorities assigned to them.

The router R₃ then transmits the flow of packets to the terminal T₃, and the quality of service request conforming to the RSVP is transmitted to the terminal T₃.

This prior art solution encounters a problem in that the verification of the resources available is effected only by the edge equipments. Thus if two quality of service requests are initiated at two different edge equipments, the result may be that it is not possible to detect that an internal router is unable to satisfy this quality of service requirement. Both quality of service requests are then granted, although one of them, or even both of them, cannot be satisfied.

In the FIG. 1 example, the terminal T₂ initiates a second quality of service request to the edge equipment R₂. This quality of service request is subject to the same processing as the request initiated by the terminal T₁ and is likewise addressed to the terminal T₃.

The flow of packets to which the edge equipment R₂ has assigned a priority follows a path R₂, R₅, R₆, R₃ to the terminal T₃.

A portion R₅-R₃ of this path is therefore common to the path taken by the flow of packets from the terminal T₁.

In the case of an economic network configuration, the links such as R₃-R₅ here may be specified to accept a certain volume of simultaneous calls that may be exceeded in statistically rare situations.

Accordingly, if the sum of the bit rates of these two flows of packets is greater than the maximum bit rate on the path R₅-R₃, the router R₅ will not be in a position to satisfy the quality of service required by at least one of the terminals T₁ and T₂. If both quality of service requests are assigned the same priority, the qualities of service of the two flows of packets will be degraded.

As a result of this mechanism, there may be a significant difference between the quality of service requested by the terminals (and accepted by the data network) and that actually provided.

Also, there exist already resource reservation devices such as that described in European patent application EP1047226. Nevertheless, the object of these devices is not to effect admission control, but actually to reserve resources in the managed network. This kind of mechanism may work if the network receives only a small number of resource reservation requests, but as soon as a concrete telecommunication network is considered, reserving resources in this way for each flow of packets represents an extremely severe penalty.

The object of the present invention is to overcome these problems by proposing a mechanism for authorizing and prohibiting quality of service requests based on the resources actually available in the data network.

To be more precise, the invention provides an admission controller for controlling admission to a data network comprising a set of edge equipments, which controller is characterized in that it comprises:
receiver means for receiving quality of service requests associated with flows of packets,
verification means for verifying that said quality of service requests may be satisfied by the internal resources of said data network, and
sending means for sending the edge equipment corresponding to said quality of service request a message authorizing or prohibiting the transmission of the associated flow of packets.

In one embodiment of the invention, the sending means and the receiving means may be adapted to communicate in accordance with the same protocol, such as the COPS protocol.

In another embodiment, these protocols are different: the sending means are adapted to send messages conforming to the COPS protocol and the receiving means may be adapted to receive quality of service requests conforming to the SIP, H.323, etc. protocols, for example.

Thus by using an admission controller, the edge equipments admit the flows of packets only if the requested quality of service can actually be provided by the network.

Since the admission controller centralizes all quality of service requests sent to the data network, this verification may be effected in a global manner.

This avoids any overprovision of resources of the data network.

The invention and its advantages are explained more clearly in the following description of embodiments of the invention given with reference to the appended drawings.

FIG. 1, already commented on, represents a prior art solution.

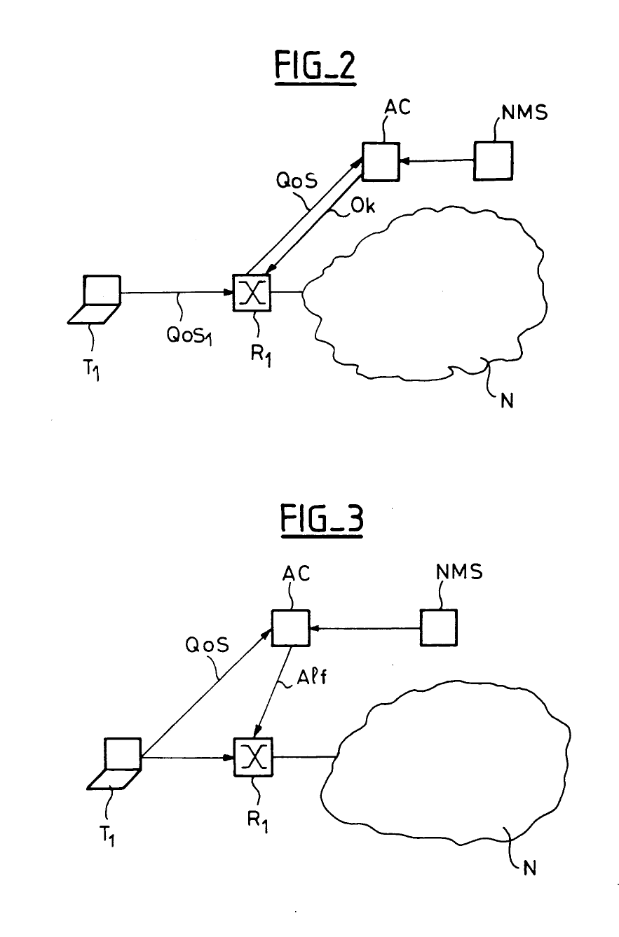

FIG. 2 depicts a first embodiment of the invention.

FIG. 3 depicts a second embodiment of the invention.

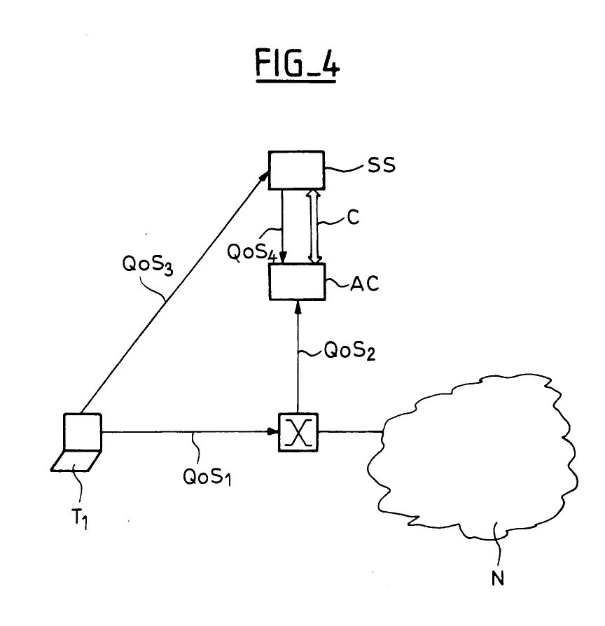

FIG. 4 depicts a third embodiment of the invention.

FIG. 2 represents a data network N comprising a set of routers R₁, R₂ . . . Rₙ. A terminal T₁ initiates a flow of packets to a terminal T₂.

This flow of packets necessitates a certain quality of service. For example, it may consist in a multimedia session necessitating a minimum bit rate. The terminal T₁ therefore sends a quality of service request QoS₁ to an edge router R₁ (in the example represented in FIG. 2, the edge equipment is an edge router, but the principle of the invention may naturally be applied to other types of network equipment).

This quality of service request may be a resource reservation request conforming to the RSVP, as previously described.

The resource reservation request comprises parameters characteristic of the quality of service requested for this flow. In particular, it may comprise the minimum bit rate required for the packets of the flow associated with the resource reservation request.

The edge router R₁ has means for transmitting this quality of service request to an admission controller AC in the form of a quality of service request QoS.

For example, this transmission may be effected using the COPS protocol defined by RFC 2748 “The COPS (Common Open Policy Service) Protocol” adopted in January 2000.

The admission controller has means for receiving this quality of service request and means for verifying that it may be satisfied by the internal resources of the data network.

To this end, the admission controller may have a knowledge of the internal resources supplied by a network management system NMS.

These internal resources may relate to the entirety of the data network N or to a portion thereof.

These internal resources may be the bandwidths of the connections (or of certain connections) between the routers constituting the data network.

Knowing the topology of the data network, routing information such as routing tables and the available bandwidth on the connections of the network, the admission controller is in a position to have an overview. Knowing all quality of service requests in transit in the data network, it can then tell if a quality of service request may actually be satisfied or not.

The admission controller also has means for sending an authorization or prohibition message Ok to the edge router R₁ corresponding to the quality of service request.

The edge router R₁ allows the transmission of the subsequent packets of the flow of packets only if an authorization message is received from the admission controller AC.

Where appropriate, this authorization message may contain degraded quality of service parameters.

This is because, in one embodiment of the invention, if the quality of service requirement may not be satisfied, given the internal resources of the data network N and quality of service requests previously authorized, it may still be possible to authorize the transmission of the flow of packets by assigning it a quality of service lower than that requested, for example by assigning it a lower priority. That priority may in particular be a color in the case of an embodiment using the DiffServ protocol.

In one embodiment of the invention, this authorization message may contain rerouting parameters for changing the path of the flow of packets toward a new path better able to provide the requested quality of service.

FIG. 3 depicts a second embodiment of the invention.

In this embodiment the quality of service request QoS is transmitted by the sender of the flow of data, which may be a terminal, an office automation application, etc., for example. It may come directly from the sender or be transmitted via an intermediate application such as a “softswitch”, for example.

In this latter case, the intermediate application may handle shaping, hypotheses, correlation between a plurality of quality of service requests, etc. prior to the transmission of a quality of service request to the admission controller AC.

The protocol employed for the transmission of this quality of service request by the sender of the flow of data may typically be the Session Initiation Protocol (SIP) or the H.323 protocol of the International Telecommunication Union (ITU-T).

In the particular situation depicted in FIG. 3, the terminal T₁ transmits a quality of service request QoS directly to the admission controller AC.

As in the preceding embodiment, the admission controller has verification means for verifying that the quality of service request may be satisfied by the internal resources of the data network N. A knowledge of these internal resources may be provided by a network management system NMS, for example.

In this embodiment, it may be up to the admission controller AC to assign priorities to the packets of the flow of packets, based on this quality of service request.

To this end, the admission controller AC may be provided with means for determining priorities from parameters contained in the quality of service requests. Those means match a priority to a given quality of service request profile determined by its parameters. For example, a quality of service request coming from an important client or a very important person (VIP) has a higher priority than a quality of service request coming from a third party, all other parameters being the same (packet loss rate, etc.).

In one embodiment, on receiving a quality of service request QoS, the admission controller AC:
extracts the destination address of the flow of packets from the request, and
determines where the flow enters the network (an entry router identifier may be indicated in the quality of service request), and then
determines the path that the flow of packets should take in the network, by looking in the routing tables of the routers through which the flow of data passes.

Each aggregate that transports the flow of packets has quality of service characteristics (bit rate, delays, packet loss rate, etc.), and those characteristics must be compared to the flows of packets already accepted and the new flow of packets.

For example, the delay of the aggregate will be the delay that the flow of packets will be subject to for connecting two routers.

Moreover, an aggregate may be characterized by a bandwidth or a bit rate, and it is necessary to verify that the sum of the bit rates (maximum, average, etc.) of the flows of packets of the aggregate is less than the bit rate of the aggregate, or at least estimated as acceptable by the aggregate.

The determination of the aggregates for a flow of packets and the verifications of the characteristics may be performed in any order. For optimum results, the verification may be effected on each termination of the aggregates, so as not to search for all the aggregates on a path if one of the first aggregates is not able to transport the flow of packets.

The admission controller AC further comprises means for transmitting a priority assignment request Aff to the edge router R₁.

This priority assignment request may conform to the COPS protocol.

A request of this kind could take the following form, for example:

| | |
|---|---|
| DEC: = | <Handle B> |
| | <Context: in, Resv> |
| | <Decision: command, Install> |
| | <Context: allocation, Resv> |
| | <Decision: command, Install> |
| | <Decision: Stateless, Priority =7> |
| | <Context: out, Resv> |
| | <Decision: command, install> |
| | <Decision: replacement, POLICY-DATA1> |

This protocol allows a remote entity, such as the admission controller AC, to control the behavior of a router.

The edge router R₁ then has means for receiving these priority assignment requests and for assigning the requested priority to the packets of the flow of packets.

These priorities and the manner in which they are assigned to the packets of the flow of packets may conform to the DiffServ mechanism.

In another embodiment, the priorities may be determined in collaboration with the “softswitch” intermediate application from which the quality of service request arrived. The admission controller then has means for communicating with this other intermediate application, which may take the form of a protocol interface or an application programming interface (API).

FIG. 4 depicts a particular situation in which the same flow of data is associated with two quality of service requests:
The first is a resource reservation request QoS₁, as described for the embodiment shown in FIG. 2. This may be an RSVP request, for example.
The second is an SIP or H.323 quality of service request QoS₃ as described in relation to FIG. 3.

As previously described, the first request gives rise to a quality of service request QoS₂ transmitted by the edge router R₁ to the admission controller AC.

The second request QoS₃ terminates at a “softswitch” intermediate application SS. It gives rise to a quality of service request QoS₄ transmitted to the admission controller AC.

The two transmissions are effected asynchronously; this means that the order in which they arrive at the admission controller AC is not fixed.

If the admission controller receives the quality of service request QoS₄ before it receives the quality of service request QoS₂, then it may simply apply a verification by comparing the parameters contained in each of the requests.

If the admission controller AC receives the quality of service request QoS₂ first, it may employ a collaboration C with the intermediate application SS, in particular to obtain supplementary information on the associated flow of packets.

As a function of the supplementary information, it may then determine traffic formatting and/or degraded quality of service parameters and transmit them to the edge router R₁.

In one embodiment of the invention, if the admission controller AC detects that a resource is frequently used, or even saturated, and therefore refuses or reroutes quality of service requests, then it may inform the network management system NMS that this configuration is too weak.

The same may apply to a resource that is underused.

In parallel with this feedback loop based on detecting crossing thresholds, the admission controller may also send statistics on the use of the network to the network management system NMS, for example periodically. The latter may then reconfigure the network optimally.

Such information may comprise:
descriptions of links (bit rate, error rate, delay, etc.),
descriptions of routers,
descriptions of routing tables, etc.

The admission controller AC may also propose a configuration of the network to the network management system NMS. The responsibility for adopting this configuration proposal may remain with the network management system.

1. Admission controller (AC) for controlling admission to a data network (N) comprising a set of edge equipments (R₁), which controller is characterized in that it comprises:
receiver means for receiving quality of service requests associated with flows of packets,
verification means for verifying that said quality of service requests may be satisfied by the internal resources of said data network, and
sending means for sending the edge equipment corresponding to said quality of service request a message authorizing or prohibiting the transmission of the associated flow of packets.

2. Admission controller according to claim 1, wherein said sending means are adapted to send authorization or prohibition messages conforming to the COPS protocol.

3. Admission controller according to either claim 1, wherein said receiver means are adapted to receive quality of service requests coming from said edge equipment and conforming to the COPS protocol, for example.

4. Admission controller according to either claim 1, wherein said receiver means are adapted to receive quality of service requests coming from the sender (T₁) of said flow of data, possibly via an intermediate application.

5. Admission controller according to claim 1, additionally comprising means for determining priorities from parameters contained in said quality of service requests, and wherein said sending means are adapted to transmit priority assignment requests based on said priorities.

6. Admission controller according to claim 1, wherein said determination is effected in collaboration with said intermediate application.

7. Admission controller according to claim 1, wherein said sending means are adapted to transmit traffic formatting and/or degraded quality of service parameters to said edge router.

8. Admission controller according to claim 1, wherein said sending means are adapted to transmit rerouting parameters to said edge router.

9. Admission controller according to claim 1, further comprising means for acquiring knowledge of said internal resources from a network management system (NMS).

10. Admission controller according to claim 1, comprising means for transmitting information on the use of said internal resources to said network management system.
